(19) United States
(12) Patent Application Publication
(10) Pub. No.: US 2019/0050915 A1
(43) Pub. Date: Feb. 14, 2019

(54) METHOD AND SYSTEM FOR FACILITATING APPRAISAL OF PROPERTIES

(71) Applicant: Vernand Morency, Tomball, TX (US)

(72) Inventor: Vernand Morency, Tomball, TX (US)

(21) Appl. No.: 15/896,990

(22) Filed: Feb. 14, 2018

Related U.S. Application Data
(60) Provisional application No. 62/542,625, filed on Aug. 8, 2017.

(51) Int. Cl. G06Q 30/02; G06Q 50/16; G06Q 10/06; G06F 17/30; G06F 15/18; H04L 9/32

(52) U.S. Cl. CPC G06Q 30/0278; G06Q 50/16; H04L 9/3231; G06F 17/30654; G06F 15/18; G06Q 10/063112

(57) ABSTRACT

Disclosed is a method for facilitating appraisal of properties. The method includes receiving an appraisal request from a requester device. Further, the method includes receiving an appraisal job posting from an appraisal management. Further, the method includes analyzing the appraisal job posting. Further, the method includes identifying at least one appraiser based on the analyzing. Further, the method includes transmitting the appraisal job posting to at least one appraiser device. Further, the method includes receiving at least one acceptance from the at least one appraiser device. Further, the method includes receiving at least one credential from the at least one appraiser device. Further, the method includes determining an eligibility of the at least one appraiser. Further, the method includes transmitting an assignment of the appraisal job posting to each of the at least one appraiser device and the appraisal management device based on the eligibility.

### FIELD OF THE INVENTION

The present disclosure generally relates to real estate appraisals. Particularly, the disclosure relates to methods and systems for facilitating appraisal of properties.

### BACKGROUND OF THE INVENTION

Conventionally, when any financial institution (FI) needs to evaluate a property, the FI contacts appraisers directly. Thereafter, the evaluation of the property is done by the appraisers manually. However, sometimes issues arise in the communication between

FI and appraiser. For example, the appraisers may submit wrong information to the FI. Further, the evaluation may not be done correctly, so it may be considered a fraud to submit such information.

To overcome this, many states in the US require FIs to go to appraiser management companies to get the appraisal done. Accordingly, the FIs do not contact appraiser directly to overcome the chances of fraud. Therefore, FIs may post the appraisal requests to the appraiser management company on software platforms. Then the appraiser management company finds the appraisers for a particular appraisal request and hire the appraiser(s) to complete the task. However, the appraiser management companies often find it challenging to locate suitable appraisers for a particular appraisal request.

Therefore, there is a need for methods and systems to connect appraiser company with appraiser effectively and in a more robust manner.

Accordingly, there is a need for improved methods and systems to facilitate appraisal of properties that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method for facilitating appraisal of properties. The method may include receiving, using a communication device, an appraisal request from a requester device associated with a requesting entity. Further, the appraisal request may include indication of a property. Further, the method may include receiving, using the communication device, an appraisal job posting from an appraisal management device associated with an Appraisal Management Company (AMC). Further, the appraisal job posting may be based on the appraisal request. Further, the method may include analyzing, using a processing device, the appraisal job posting. Further, the method may include identifying, using a processing device, one or more appraisers based on the analyzing. Further, the method may include transmitting, using the communication device, the appraisal job posting to one or more appraiser devices associated with the one or more appraisers. Further, the method may include receiving, using the communication device, at least one acceptance from the one or more appraiser devices. Further, the method may include receiving, using the communication device, one or more credentials associated with the one or more appraisers from the one or more appraiser devices. Further, the method may include determining, using the processing device, an eligibility of the one or more appraisers to fulfil the appraisal job posting based on the one or more credentials. Further, the method may include transmitting, using the processing device, an assignment of the appraisal job posting to each of the one or more appraiser devices and the appraisal management device based on the eligibility.

According to some aspects, a system for facilitating appraisal of properties is disclosed. The system may include a communication device configured for receiving an appraisal request from a requester device associated with a requesting entity. Further, the appraisal request may include indication of a property. Further, the communication device may be configured for receiving an appraisal job posting from an appraisal management device associated with an appraisal management company. Further, the appraisal job posting may be based on the appraisal request. Further, the communication device may be configured for transmitting the appraisal job posting to one or more appraiser devices associated with one or more appraisers. Further, the communication device may be configured for receiving at least one acceptance from the one or more appraiser devices. Further, the communication device may be configured for receiving one or more credentials associated with the one or more appraisers from the one or more appraiser devices. Further, the communication device may be configured for transmitting an assignment of the appraisal job posting to each of the one or more appraiser devices and the appraisal management device based on the eligibility. Further, the system may include a processing device configured for analyzing the appraisal job posting. Further, the processing device may be configured for identifying the one or more appraisers based on the analyzing. Further, the processing device may be configured for determining an eligibility of the one or more appraisers to fulfil the appraisal job posting based on the one or more credentials.

The present disclosure provides multiple advantages including connecting AMCs with appraisers effectively and in a more robust manner. The disclosed platform empowers AMCs to quickly post the job and broadcast the job. On the other hand, the disclosed platform allows appraisers to easily find and accept the jobs. The process to complete the job may be done through a messaging system. Accordingly, the platform may help the AMC who is looking for the appraisers to do the job (received from FIs) and the certified appraisers who're ready to do the job accept it by using the same platform.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 illustrates a system for facilitating appraisal of properties in accordance with an exemplary embodiment.

FIG. 3 is a flowchart of a method for facilitating appraisal of properties in accordance with an exemplary embodiment.

FIG. 4 is a flowchart of a method for determining an eligibility of the one or more appraisers to fulfil the appraisal job posting based on the one or more credentials in accordance with an exemplary embodiment.

FIG. 5 is a flowchart of a method for verifying the identity of the one or more appraisers in accordance with an exemplary embodiment.

FIG. 6 is a flowchart of a method for interacting with one or more apprentice devices in accordance with an exemplary embodiment.

FIG. 7 is a flowchart of a method for obtaining an environmental data associated with the appraisal request in accordance with an exemplary embodiment.

FIG. 8 is a flowchart of a method for receiving a natural language response corresponding to a natural language query in accordance with an exemplary embodiment.

FIG. 9 is a flowchart of a method for using machine learning to determine natural language responses in accordance with an exemplary embodiment.

FIG. 10 is a flowchart of a method for determining a validity of one or more appraisal reports in accordance with an exemplary embodiment.

FIG. 11 is a flowchart of a method for obtaining property data in accordance with an exemplary embodiment.

FIG. 12 is a flowchart of a method for retrieving property data in accordance with an exemplary embodiment.

FIG. 13 illustrates an exemplary computing system that may be employed to implement processing functionality for various embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### Overview

According to some aspects, the present disclosure provides a method that allows an Appraiser Management Company (AMC) to connect with appraisers for a job provided by a Financial Institution (FI). The method empowers the AMC to quickly post the job and broadcast the job. Further, the method empowers the appraiser to receive accept the job. The process to complete the job may be done through a messaging system.

According to some aspects, the present disclosure provides an application (such as a web/mobile application) where AMCs (or real estate agents) may post jobs on the Internet. The posted jobs may be seen by appraisers or home inspectors and may be accepted instantly based on one or more of a location, a type and a cost. The web application empowers these stakeholders to shorten the lifecycle of the complete process of finding and getting an appraisal job. Further, the web application may allow the appraisers (or home inspectors) to find jobs by using their GPS location. The radius may be increased or decreased (in miles) to find suitable jobs, thereby shortening the time to manage and travel for the completion of the jobs. Further, a collaborative message board may be provided for the discussions related to the posted jobs after the acceptance of the same by appraisers.

According to some aspects, the present disclosure provides an online platform configured to interface with an expert system such as IBM Watson™. The online platform may have several types of users who may create their profile or register over a portal. The users may include AMCs/real estate agents, appraisers/home inspectors, and trainees/apprentices. The online platform may provide a chat bot that is capable of receiving queries from users of the online platform (such as FI employees, appraisers, apprentices) and automatically provide appropriate responses. In order to provide this functionality, the expert system may be trained on domain-specific knowledge which may include a database of questions and corresponding responses. Further, the domain specific knowledge may also be in the form of decision-making rules input by a domain expert. In addition to providing responses to queries, interfacing with the expert system may also be used to validate or verify the accuracy or correctness of appraisals provided by apprentices and/or licensed appraisers. Accordingly, in some embodiments the expert system may be trained on data comprising prior appraisal forms and corresponding real estate data.

According to further aspects, the online platform that may integrate with one or more third-party applications such as Netverify®, Google Drive® and GPS. The integration may be performed using APIs such as API provided by Netverify®. Netverify® combines ID verification, identity verification, and document verification to provide a complete solution to establish the real-world identity of users (such as appraisers). Leveraging advanced technology including biometric facial recognition and machine learning, Jumio® from Netverify® helps businesses meet regulatory compliance including Anti-Money Laundering (AML) and Know Your Customer (KYC), reduce fraud, and provide a safe and secure user experience. Once their identity is determined, then a list of license numbers stored in a database may be accessed, which may be then compared with the license number provided during registration. There may be chances that those license numbers do not exist in the database, in that case a manual verification of their license may be performed by the administrator. Thus, identity management may be performed by Jumio® for ID Verification, Identity Verification, Document Verification and the license number may be validated as explained earlier.

According to some aspects, the present disclosure provides a method that allows appraisers to invite the apprentices to join the platform (or the web application) or invite them to work under them. An appraiser may be able to invite an apprentice either by email or phone. The apprentice may get a link to download the application or a referral code, which they have to enter while signing up into the online platform (or the application). Once the apprentice joins the platform (or the application) using the link shared by an appraiser, then the appraiser may be rewarded. For example, the appraiser may be rewarded with 5 credits when a new apprentice joins the platform. Therefore, for every new apprentice, the appraiser may get 5 credits. Further, when an existing apprentice gets an invite from any appraiser and joins to work under them, then also the corresponding appraiser may be rewarded 5 credits. To encourage the appraiser to invite more apprentices to join, bonus credits may be rewarded in addition. For example, if an appraiser invites 3 apprentices and they join the platform using the same link, then the appraiser may be rewarded another 10 bonus credits. Therefore, for inviting 3 apprentices, the appraiser may get a total of 25 credits, which includes 5 credits for each of the 3 apprentices and 10 credits received as a bonus. The appraisers may redeem the credits when applying for jobs. If the appraisers do not have credits in their accounts, they may have to purchase the credits to apply for jobs. An apprentice may have the same privileges which the appraiser has, however, whatever the work an apprentice performs may be considered under any appraiser. The apprentices may login/signup as an appraiser. The only difference for the apprentice signup is that the apprentice would have to enter the appraiser's email address or profile ID to complete the signup. An apprentice may work under many appraisers to complete a certain number of hours (e.g. 2000 hours) to complete the training. An appraiser may only have options to hire/train only 3 apprentices under them. However, an apprentice may be able to work with more than 5 appraisers as well.

According to some aspects, the present disclosure provides various methods for using the online platform (and/or application) by AMCs. The online platform (and/or application) may allow the AMCs to perform one or more of following: Lgin/Signup as an AMC, verify the AMC, create AMC profile, post job, invite appraiser for existing or new job, find appraiser, view appraiser information, view request/jobs, hire appraisers, communicate with appraisers and submit reviews for appraisers.

According to further aspects, the present disclosure provides various methods for using the online platform (and/or application) for appraisers. The online platform (and/or application) may allow the appraisers to perform one or more of following: login/signup as an appraiser, complete verification to become a verified appraiser, view posted jobs, accept jobs, manage accepted jobs, mark/update status of each job, communication with AMCs, manage apprentices, complete assigned job, submit report, assign work to an apprentice and submit reviews for AMCs.

According to further aspects, the present disclosure provides various methods for using the online platform (and/or application) for trainers. The trainers may apply for the training by using the mobile application. Further, the present disclosure may provide the apprentices with an interface using which they may accept a job on the behalf of their mentors and collaborate to execute the same. Further, an interface may be provided for the apprentices to help them find their mentor and work to complete the training. The online platform (and/or application) may allow the apprentices to perform one or more of following: enter Unique ID of appraiser to work under any appraiser, search for the appraiser to apply as a apprentice, work under an appraiser, work under home inspector, view posted job, apply job under any appraiser, complete job and submit report.

According to further aspects, the present disclosure provides various methods for using the online platform (and/or application) for end users (real estate agents). The online platform (and/or application) may require the real estate agents to provide their real estate agent License number/certification. to The role of the real estate agents may be to post the job on behalf of any AMC and hire a home inspector to do the inspection on any job. The real estate agents may be able to access the same features accessible to the AMCs. However, the jobs are posted by the real estate agents may be offered only to the home inspectors. Therefore, when a real estate agent posts a job then only home inspectors may be able to accept/apply for the job. Further, the job may be displayed only to the home inspectors. The online platform (and/or application) may allow the real estate agents to perform one or more of following: login/signup as a real estate agent, verify as a real estate agent, create a real estate agent profile, post job, invite home inspectors for existing or new job, find home inspectors, view home inspector information, view request/jobs, hire home inspectors, communicate with home inspectors and submit reviews for the home inspectors.

According to further aspects, the present disclosure provides various methods for using the online platform (and/or application) for home inspectors. The home inspectors may have a similar role as the appraisers. However, their evaluation/inspection criteria may be different from that of the appraisers. The role of the home inspectors may be to apply on the job posted by the real estate agents and work for them. Further, the home inspectors may hire/train apprentices. However, there may not be any restriction for the home inspectors for maximum number of apprentices. Accordingly, the apprentice may work under any home inspector. However, any task performed by the apprentice may be considered under the name of corresponding home inspector. The online platform (and/or application) may allow the home inspectors to perform one or more of following: login/signup as a home inspector, complete verification to become a verified home inspector, view posted jobs, accept jobs, manage accepted jobs, mark/update status of each job, communicate with real estate agents, manage apprentices, complete assigned jobs, submit reports, assign work to apprentices and submit reviews for real estate agents.

According to further aspects, the present disclosure provides various methods for using the online platform (and/or application) for administrators. The administrators may have complete access to the platform. The administrators may manage various services of the platform which may include one or more of manage users, manage jobs and their categories, manage emails, manage contact us forms, manage payments etc.

The present disclosure includes many aspects and features. Moreover, while many aspects and features relate to, and are described in, the context of appraising properties, embodiments of the present disclosure are not limited to use only in this context. The embodiments of the present disclosure may provide a similar service in other industries. For example, the disclosed platform may be used find financial advisors and legal experts. Further, Real Estate Tech companies (like Redfin™) may use the disclosed platform. Moreover, Fin Tech companies (like Rocket Mortgage™ by Quicken loans™) may use the disclosed platform.

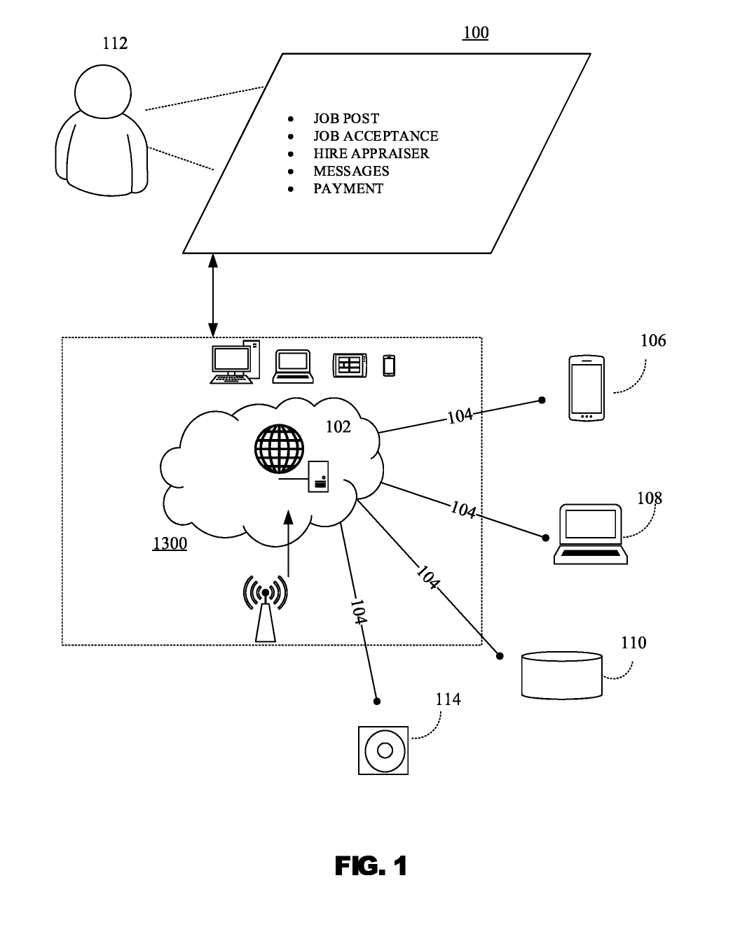

Referring now to figures, FIG. 1 is an illustration of a platform 100 consistent with various embodiments of the present disclosure. By way of non-limiting example, the online platform 100 for facilitating appraisal of properties may be hosted on a centralized server 102, such as, for example, a cloud computing service. The centralized server 102 may communicate with other network entities, such as, for example mobile devices 106 (such as a smartphone, a laptop, a tablet computer etc.), other electronic devices 108 (such as desktop computers, etc.), databases 110 (such as credential databases), sensors 114, over a communication network 104, such as, but not limited to, the Internet. Further, users of the platform may include one or more relevant parties such as requesting entities (such as banks), appraisers, Appraisal Management Companies (AMCs), apprentices, real estate agents, home inspectors, and system administrators.

A user 112, such as the one or more relevant parties, may access the online platform 100 through a software application. The software application may be embodied as, for example, but not be limited to, a website, a web application, a desktop application, and a mobile application compatible with a computing device 1300.

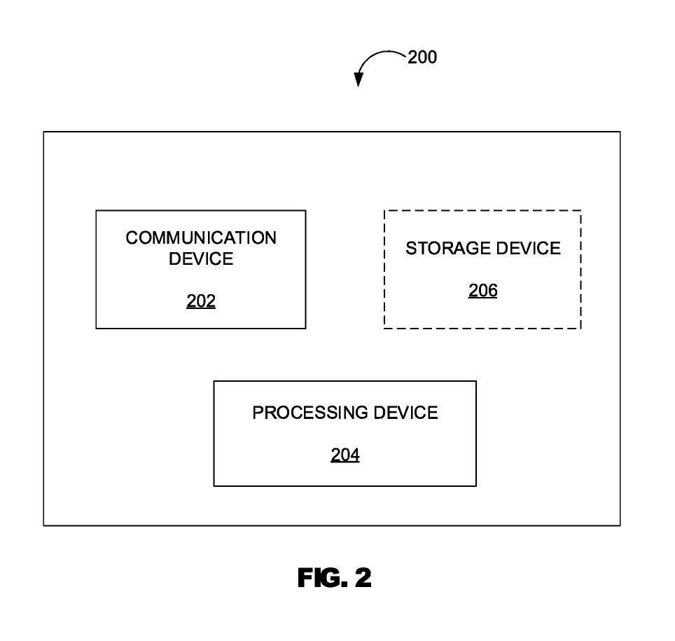

FIG. 2 illustrates a system 200 for facilitating appraisal of properties in accordance with an exemplary embodiment. The system 200 may include a communication device 202 configured for receiving an appraisal request from a requester device associated with a requesting entity. For example, the requesting entity may be a financial institution (such as a bank) or a real estate agent. Further, the appraisal request may include indication of a property. For example, the property may be real estate or a car.

Further, the communication device 202 may be configured for receiving an appraisal job posting from an appraisal management device associated with an AMC. Further, the appraisal job posting may be based on the appraisal request.

According to some state laws in the US, if any financial institution wants to evaluate any property then they are required to go to a licensed AMC, which may then hire an appraiser to complete the job. The appraiser is a practitioner who has the knowledge and expertise necessary to estimate the value of a property, or the likelihood of an event occurring, and the cost of such an occurrence. The appraiser is expected to act independently of the buying and selling parties in a transaction in order to arrive at the fair value of a property without bias. Therefore, the role of the appraiser is to provide objective, impartial, and unbiased opinions about the value of real property—providing assistance to those who own, manage, sell, invest in, and/or lend money on the security of property. The certified appraisers are practitioners who have earned an appraisal designation from a professional appraiser organization, or have met minimum education and experience requirements in the subject matter in which they issue appraisals. The AMC may select appraisers for a job based on their credentials. For example, the credentials may include, but not limited to, a license number or a license certificate which may be verified using the credential databases 110.

Further, the communication device 202 may be configured for transmitting the appraisal job posting to one or more appraiser devices associated with one or more appraisers. Further, the communication device 202 may be configured for receiving at least one acceptance from the one or more appraiser devices. Further, the communication device 202 may be configured for receiving one or more credentials associated with the one or more appraisers from the one or more appraiser devices. Further, the communication device 202 may be configured for transmitting an assignment of the appraisal job posting to each of the one or more appraiser devices and the appraisal management device based on the eligibility.

Further, the system 200 may include a processing device 204 configured for analyzing the appraisal job posting. Yet further, the processing device 204 may be configured for identifying the one or more appraisers based on the analyzing. Further, the processing device 204 may be configured for determining an eligibility of the one or more appraisers to fulfil the appraisal job posting based on the one or more credentials.

In some embodiments, the system 200 may further include a storage device 206 configured for retrieving certification data associated with the one or more appraisers based on the one or more credentials. Further, the processing device 204 may be configured for comparing the certification data with the appraisal job posting. The eligibility may be based on a result of the comparing.

In some embodiments, the communication device 202 may be further configured for receiving a biometric data from the one or more appraiser devices. The biometric data may be associated with the one or more appraisers. For example, the biometric data may be related to one or more of facial recognition, fingerprints, finger geometry (, iris recognition, vein recognition, retina scanning, voice recognition and DNA matching. Further, the processing device 204 may be configured for comparing the biometric data with multiple biometric data associated with multiple appraisers and verifying an identity of the one or more appraisers based on the comparing.

In some embodiments, the communication device 202 may be further configured for receiving one or more apprentice invitations from the one or more appraiser devices. The communication device 202 may be further configured for transmitting the one or more apprentice invitations to one or more apprentice devices. Further, the communication device 202 may be configured for receiving one or more responses from the one or more apprentice devices. Moreover, the communication device 202 may be configured for transmitting the assignment of the appraisal job posting to the one or more apprentice devices. The one or more apprentice devices may be operated by one or more apprentices. The one or more apprentices may want to become a certified appraiser. Therefore, the one or more apprentices need to be trained to work individually. To get the certification from the appraiser, the one or more apprentices may be required to complete a certain number of hours of work under a certified appraiser(s). Once the training is completed, the one or more apprentices may be awarded certifications by an appraiser certification body.

In some embodiments, the communication device 202 may be further configured for receiving an environmental data associated with the appraisal request from the one or more apprentice devices. Further, the one or more apprentice devices may include one or more sensors (such as the sensors 114) configured to sense the environmental data. The one or more sensors may include one or more of a camera, a microphone, temperature sensor, IoT sensor, smoke sensor, air quality sensor, light sensor etc. Accordingly, the environment data may include one or more of images, videos, audio, temperature, air quality, light level etc. Moreover, the communication device 202 may be configured for transmitting the environmental data to the one or more appraiser devices. Therefore, a remotely located appraiser would be able to obtain environmental data related to a property associated with the appraisal request via the one or more apprentice devices. For example, the remotely located appraiser may be able to perform a visual inspection of the property via a video/photo obtained from a camera sensor in the one or more apprentice devices. In another example, the remotely located appraiser may be able to check sound produced by a car (associated with the appraisal request) via a microphone in the one or more apprentice devices. Further, in yet another example, the remotely located appraiser may be able to supervise an appraisal process being performed by the one or more apprentices by monitoring the environmental data (e.g. audio/video recording). Additionally, in some embodiments, the environment data and/or data generated in conjunction with the appraisal process may be stored in a storage device of the online platform 100. Accordingly, a record of the appraisal process may be created including the corresponding environmental data. As a result, subsequently, one or more users (such as an appraiser and/or an apprentice) may retrieve the record and consume the corresponding environmental data.

In some embodiments, the communication device 202 may be further configured for receiving a natural language query from the one or more appraiser devices and transmitting a natural language response to the one or more appraiser devices. For example, a natural language query may be “What adverse weather conditions affect this location?”. The processing device 204 may be further configured for determining the natural language response to the natural language query based on artificial intelligence.

In some embodiments, the communication device 202 may be further configured for receiving training data including multiple appraisal requests and corresponding multiple appraisal reports. For example, the training data may be received from the online platform 100. Further, the processing device 204 may be further configured for performing machine learning based on the training data. The machine learning may be performed using third-party tools like IBM Watson™ Machine Learning engine. Further, the determining of the natural language response may be based on the machine learning. For example, the natural language response may be related to a natural language query—“In this neighborhood, what is the average price of houses sold in the past one year? The house may have 2-4 rooms, 2 toilets and 2 parking spots”.

In some embodiments, the communication device 202 may be further configured for receiving one or more appraisal reports from the one or more appraiser devices Further, the processing device 204 may be configured for analyzing the one or more appraisal reports based on one or more of artificial intelligence and a rule-based analyzer and determining the validity of the one or more appraisal reports based on the analyzing of the one or more appraisal reports. The rule-based analyzer may include rales obtained based on analyses of previous appraisal reports that were found to be valid. For example, the rules may relate to one or more of a form, a structure and content of the one or more appraisal reports.

The communication device 202 may be further configured for transmitting a validity to one or more of the one or more appraiser devices and the appraisal management device.

In some embodiments, the storage device 206 may be further configured for retrieving property data associated with the property. Further, the communication device 202 may be further configured for transmitting the property data to the one or more appraiser devices. The property data facilitates appraisal of the property. For example, the property data for real estate may include one or more of type of property, year built, parking, price/sq. ft., number of rooms, availability of heating/cooling, available appliances, and flooring.

In some embodiments, the communication device 202 may be further configured for receiving an image from the one or more appraiser devices. The image may represent at least a portion of the property. Further, the processing device 204 may be configured for identifying one or more objects represented in the image. Further, the retrieving of the property data may be based on the one or more objects. Accordingly, in a further embodiment, an appraiser may direct the corresponding appraiser device (e.g. a smartphone) towards a portion of the property (e.g. plumbing) to capture one or more images (such as a live video). The processing device 204 may then automatically recognize the context (e.g. plumbing), one or more objects and retrieve additional information (e.g. plumbing blueprint) regarding the property for display to the appraiser. In further embodiments, such additional information may be displayed as an overlay on the camera view (i.e. augmented reality).

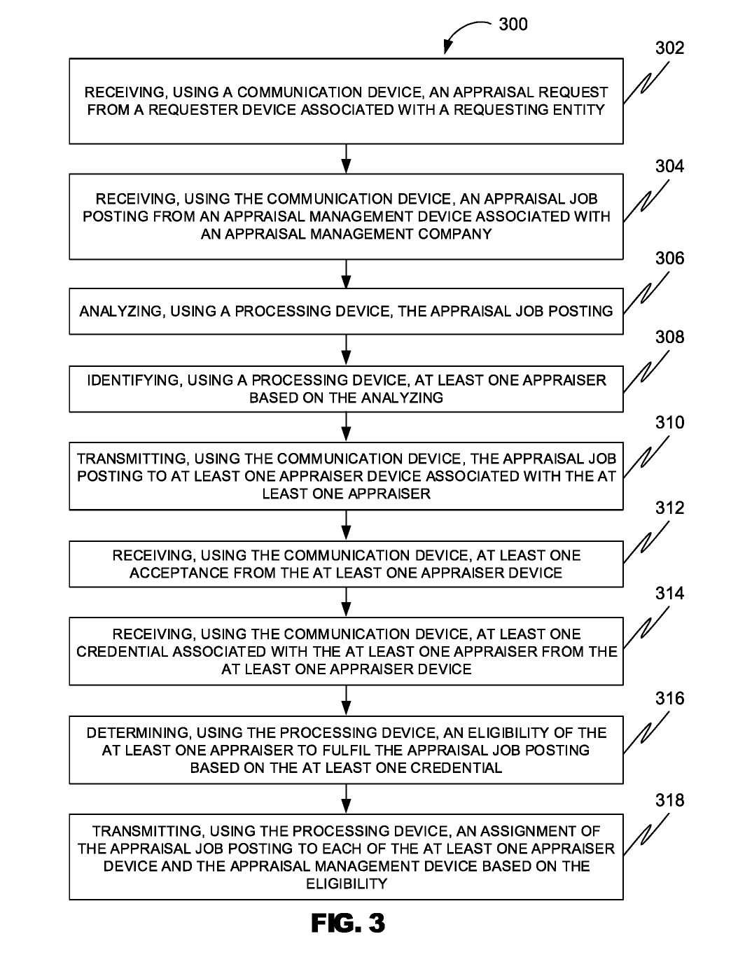

FIG. 3 is a flowchart of a method 300 for facilitating appraisal of properties in accordance with an exemplary embodiment. At 302, the method 300 may include receiving, using a communication device (such as the communication device 202), an appraisal request from a requester device associated with a requesting entity. The appraisal request may include indication of a property. For example, the requesting entity may be a financial institution (such as a bank) or a real estate agent. Further, the appraisal request may include indication of a property. For example, the property may be real estate or a car.

At 304, the method 300 may include receiving, using the communication device, an appraisal job posting from an appraisal management device associated with an Appraisal Management Company (AMC). Further, the appraisal job posting may be based on the appraisal request.

At 306, the method 300 may include analyzing, using a processing device (such as the processing device 204), the appraisal job posting. Further, at 308, the method 300 may include identifying, using a processing device, one or more appraisers based on the analyzing.

At 310, the method 300 may include transmitting, using the communication device, the appraisal job posting to one or more appraiser devices associated with the one or more appraisers.

At 312, the method 300 may include receiving, using the communication device, at least one acceptance from the one or more appraiser devices. Further, at 314, the method 300 may include receiving, using the communication device, one or more credentials associated with the one or more appraisers from the one or more appraiser devices. For example, the one or more credentials may include, but not limited to, a license number or a license certificate.

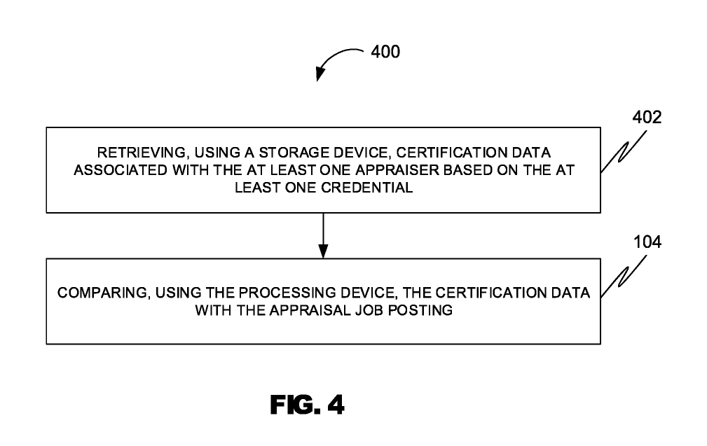

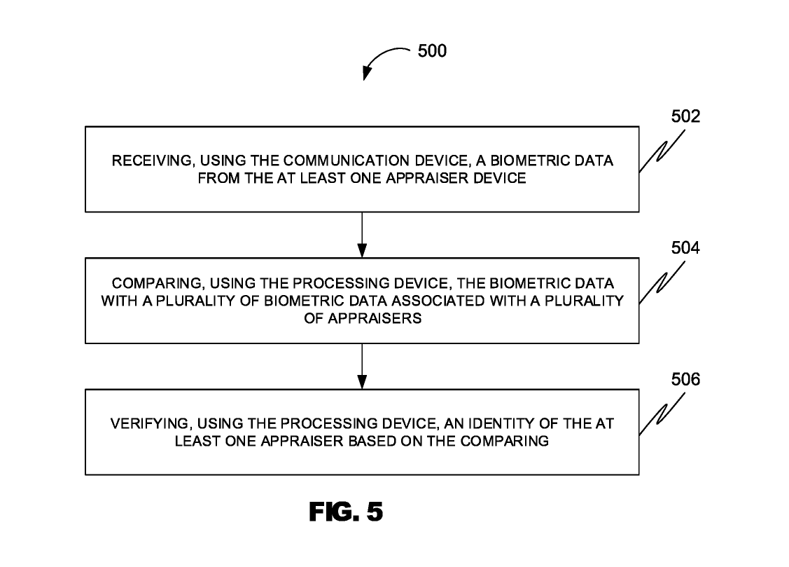

At 316, the method 300 may include determining, using the processing device, an eligibility of the one or more appraisers to fulfil the appraisal job posting based on the one or more credentials. Further, at 318, the method 300 may include transmitting, using the processing device, an assignment of the appraisal job posting to each of the one or more appraiser devices and the appraisal management device based on the eligibility. This is explained in further detail in conjunction with FIGS. 4-5 below.

FIG. 4 is a flowchart of a method 400 for determining an eligibility of the one or more appraisers to fulfil the appraisal job posting based on the one or more credentials in accordance with an exemplary embodiment. At 402, the method 400 may include retrieving, using a storage device (such as the storage device 206), certification data associated with the one or more appraisers based on the one or more credentials. At 404, the method 400 may include comparing, using the processing device, the certification data with the appraisal job posting. Further, the eligibility of the one or more appraisers may be based on a result of the comparing.

FIG. 5 is a flowchart of a method 500 for verifying the identity of the one or more appraisers in accordance with an exemplary embodiment. At 502, the method 500 may include receiving, using the communication device, a biometric data from the one or more appraiser devices. The biometric data may be associated with the one or more appraisers. For example, the biometric data may be related to one or more of facial recognition, fingerprints, finger geometry (, iris recognition, vein recognition, retina scanning, voice recognition and DNA matching. At 504, the method 500 may include comparing, using the processing device, the biometric data with a multiple biometric data associated with multiple appraisers. At 506, the method 500 may include verifying, using the processing device, an identity of the one or more appraisers based on the comparing. Further, the eligibility of the one or more appraisers may be based on a result of the verifying.

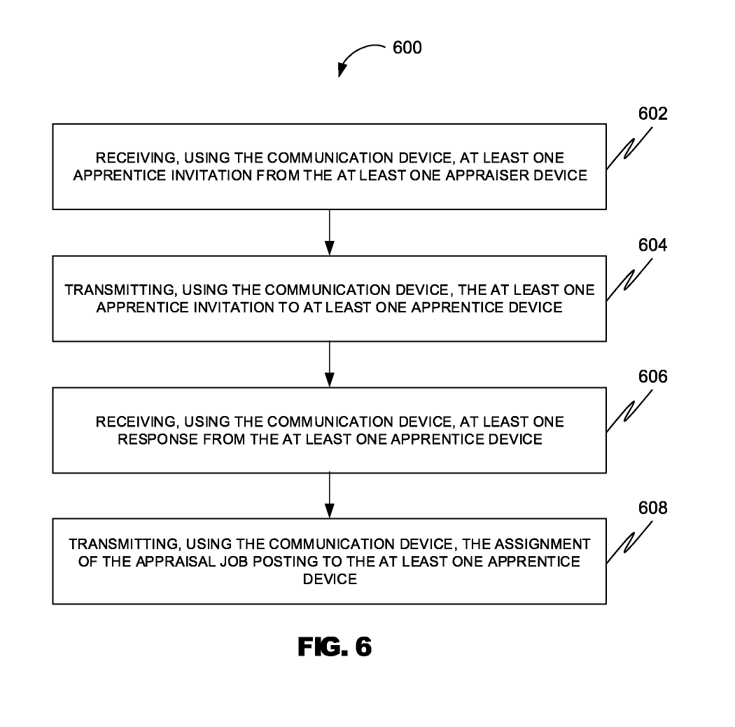

FIG. 6 is a flowchart of a method 600 for interacting with one or more apprentice devices in accordance with an exemplary embodiment. At 602, the method 600 may include receiving, using the communication device, one or more apprentice invitations from the one or more appraiser devices. At 604, the method 600 may include transmitting, using the communication device, the one or more apprentice invitations to the one or more apprentice devices. At 606, the method 600 may include receiving, using the communication device, one or more responses from the one or more apprentice devices. At 608, the method 600 may include transmitting, using the communication device, the assignment of the appraisal job posting to the one or more apprentice devices.

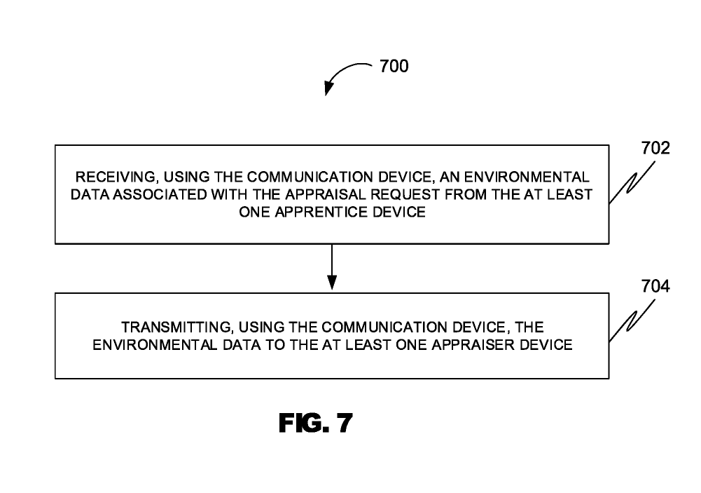

FIG. 7 is a flowchart of a method 700 for obtaining an environmental data associated with the appraisal request in accordance with an exemplary embodiment. At 702, the method 700 may include receiving, using the communication device, the environmental data associated with the appraisal request from the one or more apprentice devices. The one or more apprentice devices may include one or more sensors configured to sense the environmental data. At 704, the method 700 may include transmitting, using the communication device, the environmental data to the one or more appraiser devices. Therefore, a remotely located appraiser would be able to obtain environmental data related to a property associated with the appraisal request via the one or more apprentice devices. For example, the remotely located appraiser may be able to perform a visual inspection of the property via a video/photo obtained from a camera sensor in the one or more apprentice devices. In another example, the remotely located appraiser may be able to check sound produced by a car (associated with the appraisal request) via a microphone in the one or more apprentice devices.

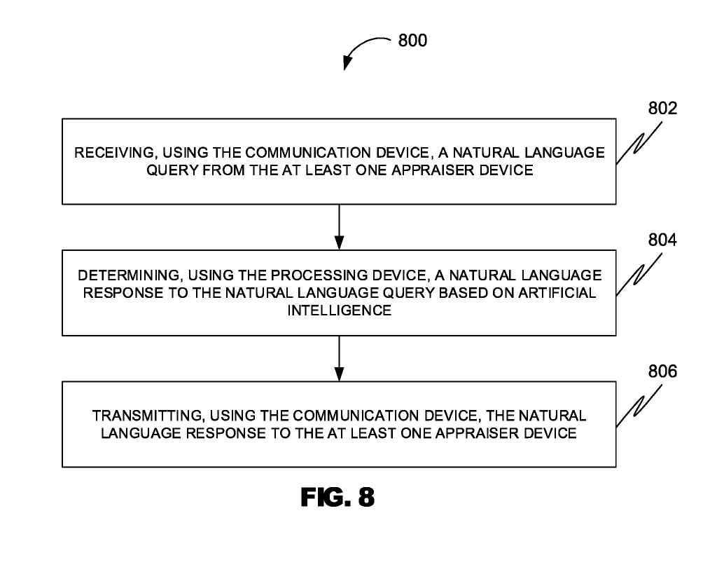

FIG. 8 is a flowchart of a method 800 for receiving a natural language response corresponding to a natural language query in accordance with an exemplary embodiment. At 802, the method 800 may include receiving, using the communication device, the natural language query from the one or more appraiser devices. For example, a natural language query may be “What adverse weather conditions affect this location?” At 804, the method 800 may include determining, using the processing device, the natural language response to the natural language query based on artificial intelligence. At 806, the method 800 may include transmitting, using the communication device, the natural language response to the one or more appraiser devices. Further, the natural language query may be used to

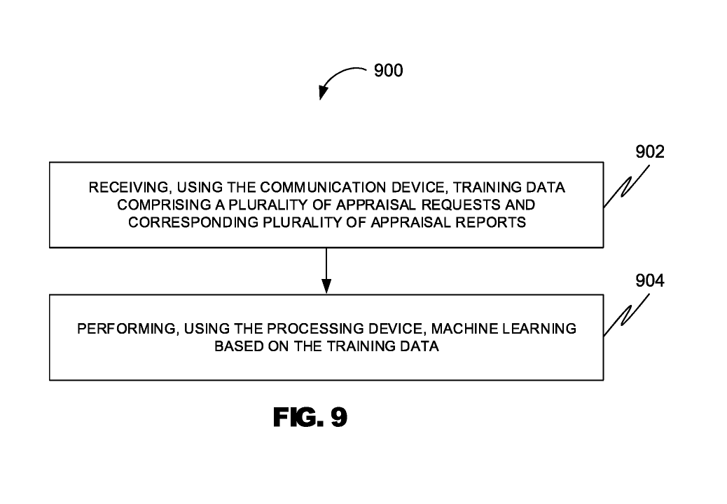

FIG. 9 is a flowchart of a method 900 for using machine learning to determine natural language responses in accordance with an exemplary embodiment. At 902, the method 900 may include receiving, using the communication device, training data including multiple appraisal requests and corresponding multiple appraisal reports. For example, the training data may be received from the online platform 100. At 904, the method 900 may include performing, using the processing device, machine learning based on the training data. The machine learning may be performed using third party tools like IBM Watson™ Machine Learning engine. Further, the determining of the natural language response may be based on the machine learning. For example, the natural language response may be related to a natural language query—“In this neighborhood, what is the average price of houses sold in the past one year? The house may have 2-4 rooms, 2 toilets and 2 parking spots”.

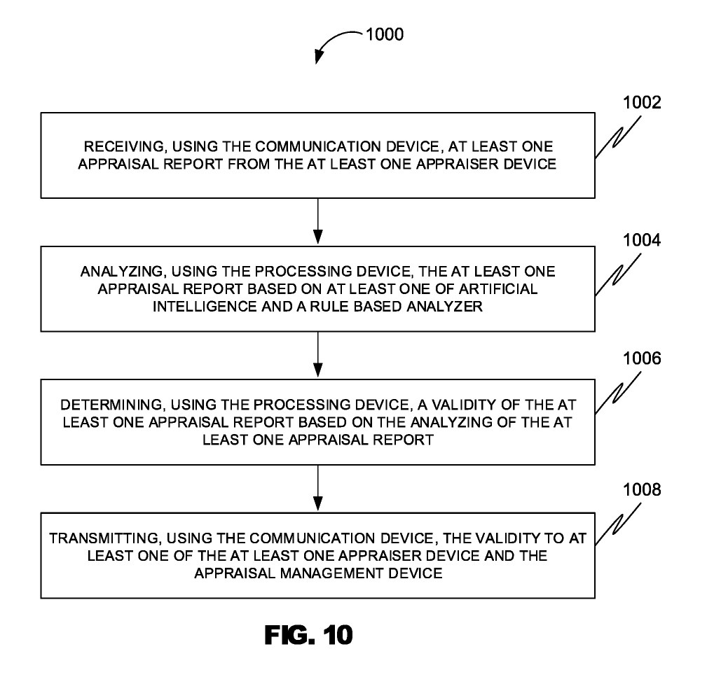

FIG. 10 is a flowchart of a method 1000 for determining a validity of one or more appraisal reports in accordance with an exemplary embodiment. At 1002, the method 1000 may include receiving, using the communication device, one or more appraisal reports from the one or more appraiser devices. At 1004, the method 1000 may include analyzing, using the processing device, the one or more appraisal reports based on one or more of artificial intelligence and a rule-based analyzer. The rule-based analyzer may include rales obtained based on analyses of previous appraisal reports that were found to be valid. For example, the rules may relate to one or more of a form, a structure and content of the one or more appraisal reports. At 1006, the method 1000 may include determining, using the processing device, a validity of the one or more appraisal reports based on the analyzing of the one or more appraisal reports. At 1008, the method 1000 may include transmitting, using the communication device, the validity to one or more of the one or more appraiser devices and the appraisal management device.

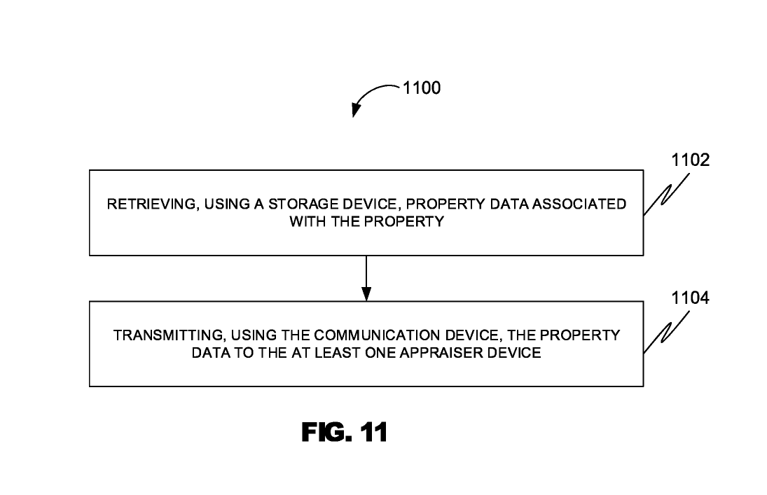

FIG. 11 is a flowchart of a method 1100 for obtaining property data in accordance with an exemplary embodiment. At 1102, the method 1100 may include retrieving, using a storage device (such as the storage device 206), property data associated with the property. For example, the property data for real estate may include one or more of type of property, year built, parking, price/sq. ft., number of rooms, availability of heating/cooling, available appliances, and flooring. At 1104, the method 1100 may include transmitting, using the communication device, the property data to the one or more appraiser devices. Further, the property data facilitates appraisal of the property.

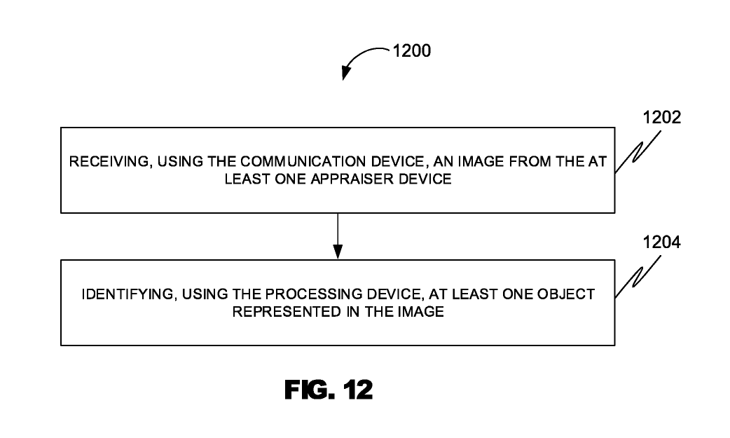

FIG. 12 is a flowchart of a method 1200 for retrieving property data in accordance with an exemplary embodiment. At 1202, the method 1200 may include receiving, using the communication device, an image from the one or more appraiser devices. Further, the image represents at least a portion of the property. At 1204, the method 1200 may include identifying, using the processing device, one or more objects represented in the image. Further, the retrieving of the property data may be based on the one or more objects. Accordingly, in a further embodiment, an appraiser may direct the corresponding appraiser device (e.g. a smartphone) towards a portion of the property (e.g. plumbing) to capture one or more images (such as a live video). The processing device 204 may then automatically recognize the context (e.g. plumbing), one or more objects and retrieve additional information (e.g. plumbing blueprint) regarding the property for display to the appraiser. In further embodiments, such additional information may be displayed as an overlay on the camera view (i.e. augmented reality).

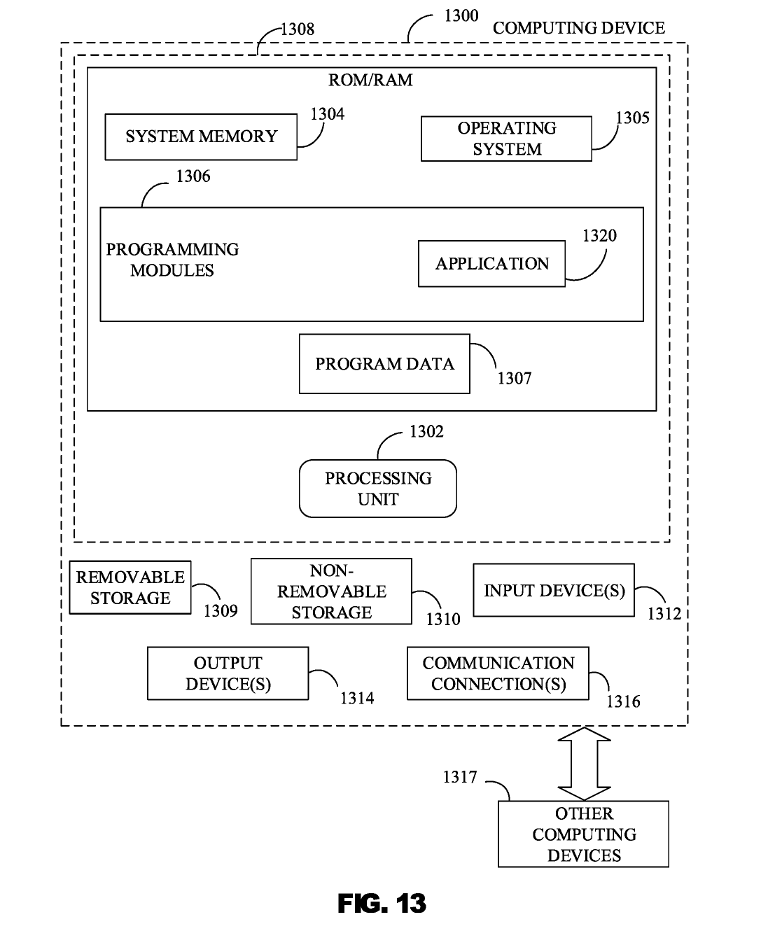

FIG. 13 is a block diagram of a system including computing device 1300. Consistent with an embodiment of the disclosure, the aforementioned memory storage and processing unit may be implemented in a computing device, such as computing device 1300 of FIG. 13. Any suitable combination of hardware, software, or firmware may be used to implement the memory storage and processing unit. For example, the memory storage and processing unit may be implemented with computing device 1300 or any of other computing devices 1318, in combination with computing device 1300. The aforementioned system, device, and processors are examples and other systems, devices, and processors may comprise the aforementioned memory storage and processing unit, consistent with embodiments of the disclosure.

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and nonvolatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM,

ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 (e.g., application 1320) may perform processes including, for example, one or more stages of methods, algorithms, systems, applications, servers, databases as described above. The aforementioned process is an example, and processing unit 1302 may perform other processes.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

I/we claim:

1. A method of facilitating appraisal of properties, the method comprising:
receiving, using a communication device, an appraisal request from a requester device associated with a requesting entity, wherein the appraisal request comprises indication of a property;
receiving, using the communication device, an appraisal job posting from an appraisal management device associated with an appraisal management company, wherein the appraisal job posting is based on the appraisal request;
analyzing, using a processing device, the appraisal job posting;
identifying, using a processing device, at least one appraiser based on the analyzing;
transmitting, using the communication device, the appraisal job posting to at least one appraiser device associated with the at least one appraiser;
receiving, using the communication device, at least one acceptance from the at least one appraiser device;
receiving, using the communication device, at least one credential associated with the at least one appraiser from the at least one appraiser device; and
determining, using the processing device, an eligibility of the at least one appraiser to fulfil the appraisal job posting based on the at least one credential;
transmitting, using the processing device, an assignment of the appraisal job posting to each of the at least one appraiser device and the appraisal management device based on the eligibility.

2. The method of claim 1, wherein the determining comprises:
retrieving, using a storage device, certification data associated with the at least one appraiser based on the at least one credential; and
comparing, using the processing device, the certification data with the appraisal job posting, wherein the eligibility is based on a result of the comparing.

3. The method of claim 2 further comprising:
receiving, using the communication device, a biometric data from the at least one appraiser device, wherein the biometric data is associated with the at least one appraiser; and
comparing, using the processing device, the biometric data with a plurality of biometric data associated with a plurality of appraisers; and
verifying, using the processing device, an identity of the at least one appraiser based on the comparing.

4. The method of claim 1 further comprising:
receiving, using the communication device, at least one apprentice invitation from the at least one appraiser device;
transmitting, using the communication device, the at least one apprentice invitation to at least one apprentice device;
receiving, using the communication device, at least one response from the at least one apprentice device; and
transmitting, using the communication device, the assignment of the appraisal job posting to the at least one apprentice device.

5. The method of claim 4 further comprising:
receiving, using the communication device, an environmental data associated with the appraisal request from the at least one apprentice device, wherein the at least one apprentice device comprises at least one sensor configured to sense the environmental data; and
transmitting, using the communication device, the environmental data to the at least one appraiser device.

6. The method of claim 1 further comprising:
receiving, using the communication device, a natural language query from the at least one appraiser device;
determining, using the processing device, a natural language response to the natural language query based on artificial intelligence; and
transmitting, using the communication device, the natural language response to the at least one appraiser device.

7. The method of claim 6 further comprising:
receiving, using the communication device, training data comprising a plurality of appraisal requests and corresponding plurality of appraisal reports; and
performing, using the processing device, machine learning based on the training data, wherein the determining of the natural language response is based on the machine learning.

8. The method of claim 1 further comprising:
receiving, using the communication device, at least one appraisal report from the at least one appraiser device; and
analyzing, using the processing device, the at least one appraisal report based on at least one of artificial intelligence and a rule based analyzer; and
determining, using the processing device, a validity of the at least one appraisal report based on the analyzing of the at least one appraisal report; and
transmitting, using the communication device, the validity to at least one of the at least one appraiser device and the appraisal management device.

9. The method of claim 1 further comprising:
retrieving, using a storage device, property data associated with the property; and
transmitting, using the communication device, the property data to the at least one appraiser device, wherein the property data facilitates appraisal of the property.

10. The method of claim 9 further comprising:
receiving, using the communication device, an image from the at least one appraiser device, wherein the image represents at least a portion of the property; and
identifying, using the processing device, at least one object represented in the image, wherein the retrieving of the property data is based on the at least one object.

11. A system for facilitating appraisal of properties, the system comprising:
a communication device configured for:
receiving an appraisal request from a requester device associated with a requesting entity, wherein the appraisal request comprises indication of a property;
receiving an appraisal job posting from an appraisal management device associated with an appraisal management company, wherein the appraisal job posting is based on the appraisal request;
transmitting the appraisal job posting to at least one appraiser device associated with at least one appraiser;
receiving at least one acceptance from the at least one appraiser device;
receiving at least one credential associated with the at least one appraiser from the at least one appraiser device; and
transmitting an assignment of the appraisal job posting to each of the at least one appraiser device and the appraisal management device based on the eligibility; and
a processing device configured for:
analyzing the appraisal job posting;
identifying the at least one appraiser based on the analyzing; and
determining an eligibility of the at least one appraiser to fulfil the appraisal job posting based on the at least one credential.

12. The system of claim 11 further comprising a storage device configured for retrieving certification data associated with the at least one appraiser based on the at least one credential, wherein the processing device is further configured for comparing the certification data with the appraisal job posting, wherein the eligibility is based on a result of the comparing.

13. The system of claim 12, wherein the communication device is further configured for receiving a biometric data from the at least one appraiser device, wherein the biometric data is associated with the at least one appraiser, wherein the processing device is further configured for:
comparing the biometric data with a plurality of biometric data associated with a plurality of appraisers; and
verifying an identity of the at least one appraiser based on the comparing.

14. The system of claim 11, wherein the communication device is further configured for:
receiving at least one apprentice invitation from the at least one appraiser device;
transmitting the at least one apprentice invitation to at least one apprentice device;
receiving at least one response from the at least one apprentice device; and
transmitting the assignment of the appraisal job posting to the at least one apprentice device.

15. The system of claim 14, wherein the communication device is further configured for:
receiving an environmental data associated with the appraisal request from the at least one apprentice device, wherein the at least one appraiser device comprises at least one sensor configured to sense the environmental data; and
transmitting the environmental data to the at least one appraiser device.

16. The system of claim 11, wherein the communication device is further configured for:
receiving a natural language query from the at least one appraiser device;
transmitting a natural language response to the at least one appraiser device, wherein the processing device is further configured for determining the natural language response to the natural language query based on artificial intelligence.

17. The system of claim 16, wherein the communication device is further configured for receiving training data comprising a plurality of appraisal requests and corresponding plurality of appraisal reports, wherein the processing device is further configured for performing machine learning based on the training data, wherein the determining of the natural language response is based on the machine learning.

18. The system of claim 11, wherein the communication device is further configured for:
receiving at least one appraisal report from the at least one appraiser device; and
transmitting a validity to at least one of the at least one appraiser device and the appraisal management device, wherein the processing device is further configured for:
analyzing the at least one appraisal report based on at least one of artificial intelligence and a rule based analyzer; and
determining the validity of the at least one appraisal report based on the analyzing of the at least one appraisal report.

19. The system of claim 11 further comprising a storage device configured for retrieving property data associated with the property, wherein the communication device is further configured for transmitting the property data to the at least one appraiser device, wherein the property data facilitates appraisal of the property.

20. The system of claim 19, wherein the communication device is further configured for receiving an image from the at least one appraiser device, wherein the image represents at least a portion of the property, wherein the processing device is further configured for identifying at least one object represented in the image, wherein the retrieving of the property data is based on the at least one object.
